(19) United States
(12) Patent Application Publication
(10) Pub. No.: US 2008/0017751 A1
(43) Pub. Date: Jan. 24, 2008

(54) Recipfan plane

(76) Inventors: Jim Griswold, Mesa, AZ (US); Charles N. Hughes, Mesa, AZ (US)

Correspondence Address: YOUNG & BASILE, P.C., 3001 WEST BIG BEAVER ROAD, SUITE 624, TROY, MI, 48084, US

(21) Appl. No.: 11/489,205

(22) Filed: Jul. 19, 2006

(51) Int. Cl. B64C 37/02

(52) U.S. Cl. 244/2

(57) ABSTRACT

An aircraft design that is powered by an automotive engine. The aircraft having a specifically designed fan stage of a fan jet gas turbine engine located closer to the fuselage of the aircraft and to the automotive engine, eliminating the need for an expensive gear box. By locating the fan closer to the engine, the drive shaft can be shortened, thereby reducing the resonances associated with a longer drive shaft. The forward location of the fan gives the aircraft additional ground clearance, allowing for a normal rotation amount during take off and landing.

### FIELD OF THE INVENTION

The present invention relates in general to an aircraft, and more particularly to a low cost aircraft that is powered by an automotive engine and propelled by a device similar to the fan stage of a fan jet gas turbine engine.

### BACKGROUND

Engines specially designed for aeronautical applications are high in price, which has lead to experimentation of alternative engine configurations for use in the aircraft industry, including the use of automotive engines. Automotive engines are currently being used in small aircraft applications as an alternative to engines that are specially designed for aircraft use. However, because automotive engines are designed for use in automobiles and not for use in aircrafts, the automotive engines operate at much higher RPM's than an aircraft propeller can operate. Since an aircraft propeller cannot rotate at such high RPM's, an additional component, such as a gear box is required to reduce the RPM's. The specially configured gear boxes are costly to implement.

### SUMMARY OF INVENTION

The present invention is a low-cost aircraft that is powered by an automotive engine. The automotive engine drives a fan device, which in turn propels the aircraft. The fan device can be comprised of the fan and stator stage similar to that in a fan jet gas turbine engine. The turbine fan device can be located forward in the frame of the aircraft, closer to the engine which is located at or near the center of the fuselage. By locating the turbine fan close to the engine, the drive shaft can be significantly shortened. The shortened drive shaft will result in a significant reduction of torsional and bending resonances produced in the aircraft during operation. A duct can be connected to the turbine fan component for discharging the air out of the aircraft through the tail.

Unlike the current airframes which are made of either a costly composite construction or aluminum that requires a numerous amount of riveting and high labor costs, the airframe can be made of aluminum and assembled using the “weld-bond” process. The weld-bond process uses an adhesive to join aluminum parts together. The joint is then laser spot welded from the reverse side. The laser spot weld secures the two pieces together while the adhesive is cured in an oven. The adhesive is cured in an oven at an elevated temperature. While the adhesive is cured in the oven, simultaneously the aluminum will reach a higher strength condition through an aging process.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a side view of the aircraft illustrating the automotive engine and turbine fan features.

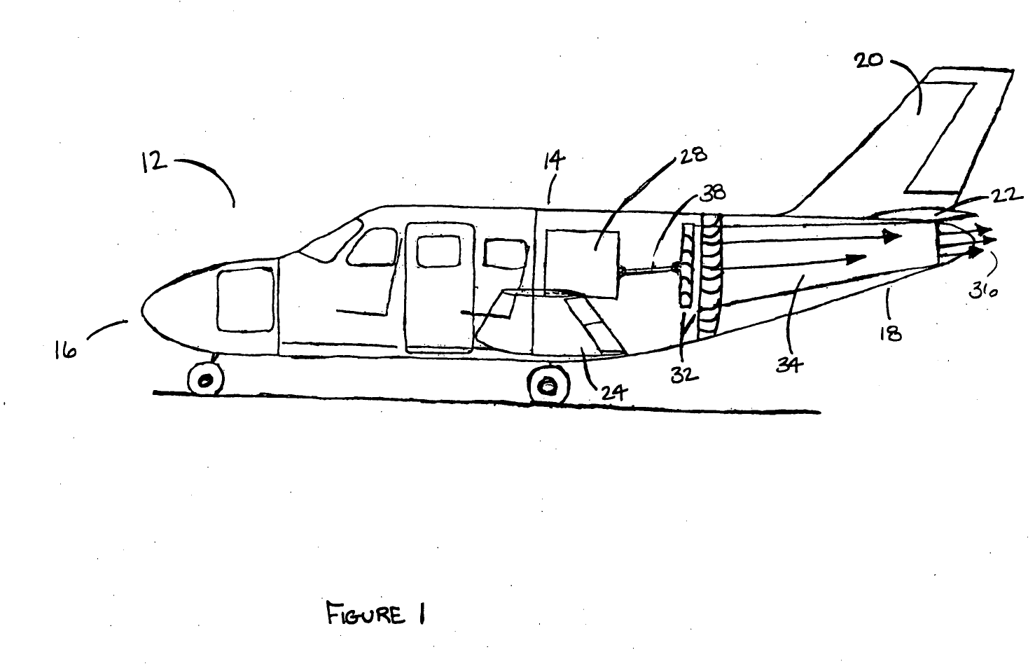

### DESCRIPTION OF PREFERRED EMBODIMENT

According to the present invention, the aircraft 12 generally includes a pair of main wings 24, a pair of tail wings 22 and a rudder 20. Located between the nose of the plane 16 and the tail of the plane 18 is the fuselage 14. The fuselage 14 houses a cabin. In the preferred embodiment, the cabin can have a width of about 50 inches. The aircraft cabin can accommodate up to five persons, two in the cock pit and three behind the cockpit. The controls of the aircraft are located in the cockpit of the aircraft.

An engine 28 can be disposed behind the cabin, near the center of the fuselage 14. The engine can be an automotive engine. In the preferred embodiment, the aircraft can be powered by a GM LQ-9 6L Vortec engine or other aluminum small-block V8 engine having a dual electrical system and dual ignition system down to the coils on each spark plug. The engine can operate at 3750 rpm and 275 horsepower at std/sl. The engine 28 can be connected to a fan device 32 via a drive shaft 38. The fan device 32 can be comprised of a specifically designed fan stage of a fan jet gas turbine engine followed by a stator stage. In the preferred embodiment, the thrust is provided by a 30″ diameter direct drive fan and stator assembly. The turbine fan 32 can eliminate the need for an expensive gear box. The turbine fan 32 can be located forward in the airframe, closer to the engine 28. By locating the turbine fan 32 closer to the engine 28, the length of the shaft 38 can be shortened. The present invention eliminates dangerous torsional and bending resonances of the prop shaft. A duct 34 can connect the turbine and stator 32 to an opening 36 in the tail of the plane 18. The duct 34 can discharge the air out of the aircraft 12 through the tail of the plane 18.

In the preferred embodiment, the aircraft 12 can include a pair of wings 24 that extend outward from substantially center of the fuselage 14. The wing span can extend about 37.4 feet. The wing aspect ratio can be 9 to 1. The aircraft 12 can have a gross weight of 3300 pounds and an empty weight of 1900 pounds. The aircraft 12 can have a wetted area of about 620 to 650 ft². The aircraft 12 can hold about 90 gallons of fuel. The engine consumes regular grade automobile fuel at a rate of about 0.424 lbs/hp/hr. The aircraft 12 can have a stall speed of 58-59 knots and a top speed of between 230 and 250 knots. The aircraft can have a take-off distance of about 1000 feet and can climb at a rate of 1700 feet per minute. Once in flight, the aircraft can cruise at an altitude of about 7000 feet at a speed of 220 knots. The aircraft 12 can include any suitable retracting landing gear. The landing gear can be located substantially center under the fuselage 14.

The airframe can be composed of an aluminum frame. The aluminum frame can be assembled using a weld-bonding process, obviating the need for expensive riveting costs or expensive composite. A weld-bond process combines bonding and welding to join pieces of aluminum. The pieces of aluminum are adhered together at a joint. On the reverse side of the joint, the area is laser-spot welded. The spot weld holds the adhesive in place during the curing process eliminating the need for multiple holding fixtures until the adhesive is cured. The adhesive is cured and the aluminum is aged simultaneously in an oven at an elevated temperature.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. An aircraft comprising:
a fuselage having a front end, a rear end, and a passenger cabin therebetween;
first and second wings attached to and extending from opposite sides of the exterior of the fuselage, the first and second wings substantially center of the fuselage between the front and rear ends;
a landing gear assembly disposed substantially center of the fuselage;
an automobile engine mounted to the fuselage rearward of the passenger cabin;
fan means disposed in the fuselage near the automobile engine;
a drive shaft extending longitudinally in the fuselage, the drive shaft operably connecting the automobile engine to the fan means; and
means for discharging the air out of the rear end of the fuselage.

2. The aircraft of claim 1, wherein the fuselage further comprises a weld-bonded aluminum frame.

3. The aircraft of claim 1, wherein the landing gear assembly is moveable from a retracted position during flight to an extended position for landing.

4. The aircraft of claim 1, wherein the automobile engine further comprises a small-block engine having eight cylinders arranged in a V configuration.

5. The aircraft of claim 1, wherein the automobile engine is mounted approximately center in the fuselage.

6. The aircraft of claim 1, wherein the fan means further comprises:
a fan stage; and
a stator stage.

7. The aircraft of claim 6, wherein the fan stage further comprises a 30 inch diameter direct drive fan.

8. The aircraft of claim 1, wherein the air discharging means further comprises a duct connecting the fan means to an exhaust opening at the rear of the fuselage.

9. An aircraft comprising:
a fuselage having a front end, a rear end, and a passenger cabin therebetween, the fuselage body formed from a weld-bonded aluminum frame;
first and second wings attached to and extending from opposite sides of the exterior of the fuselage, the first and second wings substantially center of the fuselage between the front and rear ends;
a landing gear assembly moveable from a retracted position during flight to an extended position for landing;
an automobile engine mounted to the fuselage rearward of the passenger cabin, at approximately center of the fuselage, the automotive engine having eight cylinders arranged in a V configuration;
a fan device disposed in the fuselage near the automobile engine, the fan device comprising a fan stage and a stator stage;
a drive shaft operably joining the fan device and the automobile engine; and
a duct connecting the fan means to an exhaust opening at the rear of the fuselage.
